(19) United States
(12) Patent Application Publication
(10) Pub. No.: US 2018/0223126 A1
(43) Pub. Date: Aug. 9, 2018

(54) COMPOSITIONS FOR METAL PACKAGING COATINGS

(71) Applicant: Eastman Chemical Company, Kingsport, TN (US)

(72) Inventors: Damiano Beccaria, Benevagienna (IT); Jeremy Richard Lizotte, Gray, TN (US); Sandra Case, Kingsport, TN (US); Jessica Lee Nichol, Fall Branch, TN (US)

(73) Assignee: Eastman Chemical Company, Kingsport, TN (US)

(21) Appl. No.: 15/606,063

(22) Filed: May 26, 2017

Related U.S. Application Data
(63) Continuation-in-part of application No. 15/427,662, filed on Feb. 8, 2017, now abandoned.

(51) Int. Cl. C09D 167/02; C08G 63/199; B65D 25/14

(52) U.S. Cl. CPC C09D 167/02; C08K 3/22; B65D 25/14; C08G 63/199

(57) ABSTRACT

The present invention provides crosslinked polyester compositions for use in coating metal. The polyester comprises residues of at least one aromatic acid; 2,2,4,4-tetramethyl-1,3-cyclobutanediol and at least one polyol different than 2,2,4,4-tetramethyl-1,3-cyclobutanediol wherein the polyester has a glass transition temperature greater than 75° C., an acid value of 1 mg KOH/g to 6 mg KOH/g, and a number average absolute molecular weight of 4000 g/mol to 18000 g/mol. The compositions are useful for coating metal surfaces for food contact applications and are particularly useful for coating metal can ends.

### CROSS REFERENCE TO RELATED APPLICATIONS

This application is a Continuation-in-Part of U.S. patent application Ser. No. 15/427,662, filed Feb. 8, 2017, the contents of which are incorporated herein by reference in their entirety.

### FIELD OF THE INVENTION

This invention pertains to thermosetting coating compositions. More particularly, this invention pertains to thermosetting coating compositions comprising a curable, aromatic polyester containing 2,2,4,4-tetramethyl-1,3-cyclobutanediol, and a crosslinker.

### BACKGROUND OF THE INVENTION

Due to potential health and safety concerns over the use of bisphenol A containing epoxy materials in food contact applications, can makers and the can coating industry have begun to look for alternatives to the traditional bisphenol A based epoxy coating formulations. Polyester based coatings have emerged as potential materials that may provide suitable performance. However, initial polyester based formulation alternatives have not performed to the same level as previous BPA epoxy based systems especially in terms of overall robustness across food types for retort/sterilization resistance. These deficiencies have led to increases in film thickness and reduced shelf life. Therefore, a need exists for new polyester materials for use in metal packaging and coil coating applications, and in particular in food packaging applications, which have improved universal sterilization resistance.

### SUMMARY OF THE INVENTION

According to an embodiment, the present disclosure concerns a polyester for use in metal coating applications. The polyester consists of residues of:
(a) at least one aromatic acid;
(b) 2,2,4,4-tetramethyl-1,3-cyclobutanediol; and
(c) at least one polyol different than 2,2,4,4-tetramethyl-1,3-cyclobutanediol;
wherein the polyester has a glass transition temperature greater than 75° C., an acid value of 1 mg KOH/g to 6 mg KOH/g, and a number average (Mₙ) absolute molecular weight of 4000 g/mol to 18000 g/mol.

In another embodiment, the present invention concerns a metal coating composition comprising:
(A). about 3 weight percent to about 40 weight percent, based on the total weight of (A), (B), and (C) of an aromatic polyester, consisting of
   i. aromatic diacid residues;
   ii. about 30 mole percent to 90 mole percent, based on the total moles of diol and polyol residues, of the residues of 2,2,4,4-tetramethyl-1,3-cyclobutanediol; and
   iii. about 10 mole percent to about 70 mole percent of the residues of at least one polyol chosen from 1,4-cyclohexane dimethanol, 1,3-cyclohexane dimethanol, neopentyl glycol, ethylene glycol, 2-methyl 1,3-propane diol, 1,6-hexanediol, trimethylol propane or a combination thereof based on the total moles of diol and polyol residues;
wherein said curable, aromatic polyester has a number average absolute molecular weight of from about 4000 g/mol to about 18000 g/mol, a glass transition temperature of greater than 75° C., and an acid number of about 1 mg KOH/g to about 6 mg KOH/g of polyester;
(B). about 5 weight percent to about 20 weight percent, based on the total weight of (A), (B), and (C), of at least one crosslinker; and
(C). about 30 weight percent to about 70 weight percent, based on the total weight of (A), (B), and (C), of at least one solvent; and
(D). optionally about 10 weight percent to about 40 weight percent, based on the total weight of (A), (B), (C) and (D) of at least one pigment compound wherein the total weight percent of (A), (B), (C) and (D) equals 100 weight percent.

### DETAILED DESCRIPTION

Commercially available polyester polyols typically have two performance issues. Polyester polyols having molecular weights of less than 6,000 g/mol provide formulators with materials that achieve the desired solids at the needed application viscosity, but the achievable glass transition temperatures and sterilization resistance are restricted by the choice of economically feasible monomers and low molecular weight. Alternatively, materials can reach higher glass transition temperatures (>75° C.) by increasing molecular weight and specific monomer choice, but these materials require more dilution to achieve the solution viscosity needed for the application methods that are typical to the metal packaging and coil coating industry.

We have found that crosslinked coatings of TMCD (2,2,4,4-tetramethyl-1,3-cyclobutanediol) containing polyester compositions enable achievement of high glass transition temperatures and high sterilization resistance without high molecular weight (>20000 g/mol) and the associated low solids issue.

In one embodiment, our invention provides a polyester consisting of residues of: (a) at least one aromatic acid; (b) 2,2,4,4-tetramethyl-1,3-cyclobutanediol; and (c) at least one polyol different than 2,2,4,4-tetramethyl-1,3-cyclobutanediol; wherein the polyester has a glass transition temperature greater than 75° C., an acid value of 1 mg KOH/g to 6 mg KOH/g, and a number average absolute molecular weight of 4000 g/mol to 18000 g/mol.

In another embodiment, our invention provides a polyester for use in metal coating applications consisting of residues of (a) aromatic acids, (b) 2,2,4,4-tetramethyl-1,3-cyclobutanediol; and (c) 1,4-cyclohexane dimethanol; 1,3-cyclohexane dimethanol, neopentyl glycol, ethylene glycol, 2-methyl 1,3-propane diol, 1,6-hexane diol, trimethylol propane or a combination thereof wherein the polyester has a glass transition temperature greater than 75° C., an acid value of 1 mg KOH/g to 6 mg KOH/g, 4000 g/mol to 18000 g/mol number average absolute molecular weight and an inherent viscosity of approximately 0.2-0.5 IhV.

In another embodiment, our invention provides a metal coating composition comprising a polyester consisting of residues of (a) an aromatic acid; (b) 2,2,4,4-tetramethyl-1,3-cyclobutanediol; and (c) 1,4-cyclohexane dimethanol; 1,3-cyclohexane dimethanol, neopentyl glycol, ethylene glycol, 2-methyl 1,3-propane diol or 1,6-hexane diol or trimethylol propane, wherein the polyester has a glass transition temperature greater than 75° C. and an acid value of 1 mg KOH/g to 6 mg KOH/g; and an isocyanate crosslinker.

In another embodiment, our invention provides a metal coating composition comprising (a) an aromatic polyester, (b) a crosslinker, (c) solvent and optionally (d) pigment.

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties sought to be obtained by the present invention. At the very least, each numerical parameter should be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

As used in the specification and the appended claims, the singular forms “a,” “an” and “the” include their plural referents unless the context clearly dictates otherwise. For example, a reference to a “polyester,” a “dicarboxylic acid”, a “residue” is synonymous with “at least one” or “one or more” polyesters, dicarboxylic acids, or residues and is thus intended to refer to both a single or plurality of polyesters, dicarboxylic acids, or residues. In addition, references to a composition containing or including “an” ingredient or “a” polyester is intended to include other ingredients or other polyesters, respectively, in addition to the one named. The terms “containing” or “including” are intended to be synonymous with the term “comprising”, meaning that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

Also, it is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

The term “aromatic” is intended to have its common meaning as would be understood by persons having ordinary skill in the art, that is benzeneoid or other aromatic systems.

The term “curable, aromatic polyester”, as used herein, is synonymous with the term “resin” and is intended to mean a thermosetting surface coating polymer prepared by the polycondensation of one or more specific acid components, diol components, and polyol components. The curable, aromatic polyester of the present invention is a thermoset polymer and is suitable as a resin for solvent-based coating. This polyester has an absolute molecular weight, typically from about 4000 g/mol to about 18000 g/mol, and would not be suitable for latex paint coatings or shaped objects by casting, blow molding, and other thermoforming processes commonly used for thermoplastic polymers. The polyester has a reactive functional group, typically a hydroxyl group or carboxyl group for the purpose of later reacting with an isocyanate crosslinker in a metal coating formulation. The functional group is controlled by having either excess diol or acid (from dicarboxylic acid or tricarboxylic acid) in the polyester resin composition. The desired crosslinking pathway will determine whether the polyester resin will be hydroxyl-terminated or carboxylic acid-terminated. This concept is known to those skilled in the art and described, for example, in Organic Coatings Science and Technology, 2nd ed., p. 246-257, by Z. Wicks, F. Jones, and S. Pappas, Wiley, New York, 1999.

In one general embodiment, our invention comprises a polyester comprising (a) at least one acid; (b) a diol; and (c) at least one polyol different than the diol component (b).

The acid component comprises aromatic acids such as isophthalic acid, terephthalic acid, naphthalene dicarboxylic acid or a combination thereof.

The diol component comprises, 2,2,4,4-tetramethyl-1,3-cyclobutanediol (TMCD).

The polyol component different than (TMCD) includes polyols such as 1,4-cyclohexane dimethanol, 1,3-cyclohexane dimethanol, neopentyl glycol, ethylene glycol, 2-methyl 1,3-propane diol, 1,6-hexanediol, trimethylol propane or a combination thereof.

Catalysts are used to accelerate the rate of the polycondensation reaction. The catalyst may be any food grade catalyst known in the art for the formation of a polyester resins. For example, FASCAT® 9100 (monobutyltin oxide) and FASCAT® 9102 (monobutyltin tris (2-ethylhexanoate)) available from PMC Organometallix™ and CYCAT® XK 406 N, (a phosphoric acid derivative) available from Allnex Belgium SA may be used in this invention. The amount of catalyst may be determined by routine experimentation as understood by those skilled in the art. Preferably, a catalyst is added in amounts ranging from about 0.01 to about 1.00 weight percent, based on the amount of reactants.

Isocyanates can be used as crosslinkers in accordance with the invention. Representative isocyanates include, but are not limited to, at least one compound chosen from toluene diisocyanate, diphenylmethane 4,4′-diisocyanate, methylenebis-4,4′-isocyanatocyclohexane, isophorone diisocyanate, 1,6-hexamethylene diisocyanate, 1,4-cyclohexane diisocyanate, p-phenylene diisocyanate, and triphenylmethane 4,4′,4″-triisocyanate, tetramethyl xylene diisocyanate, metaxylene diisocyanate, polyisocyanates, 1,4-butylene diisocyanate, methylene bis (4-cyclohexyl isocyanate), isophorone diisocyanate and isocyanate-terminated adducts of ethylene glycol, 1,4-butylene glycol, and trimethylol propane.

Phenolic and amino materials can also be used as crosslinkers. Suitable phenolics include phenolic resins derived from ortho, meta, para cresols along with phenol and can include other functionally substituted phenols. Examples of suitable phenolic materials that can be employed include phenol, cresol, p-phenylphenol, p-tert-butylphenol, p-tert-amylphenol, cyclopentylphenol, cresylic acid, and combinations thereof. Suitable amino materials include melamine and benzoguamine and related resins.

The coating composition can also comprise isocyanate-terminated adducts of diols and polyols, such as ethylene glycol, 1,4-butylene glycol, trimethylol propane, etc., as crosslinkers. These crosslinkers are formed by reacting more than one mole of a diisocyanate, such as those mentioned, with one mole of a diol or polyol to form a higher molecular weight isocyanate prepolymer with a functionality of 2 to 3. Some commercial examples of isocyanate-terminated adducts include isocyanate crosslinkers sold under the DESMODUR™ and MONDUR™ product lines by Covestro AG.

Examples of aliphatic isocyanates include 1,6-hexamethylene diisocyanate, 1,4-butylene diisocyanate, methylene bis(4-cyclohexyl isocyanate), isophorone diisocyanate, and combinations thereof. Mixtures of isocyanate crosslinkers can also be employed.

Stoichiometric calculations for the curable polyester and isocyanate reaction are known to those skilled in the art and are described in The Chemistry of Polyurethane Coatings, Technical Publication p. 20, by Bayer Material Science, 2005. Persons having ordinary skill in the art will understand that crosslinking between the polyester resin and isocyanate reaches maximum molecular weight and optimal properties associated with molecular weight at an isocyanate:hydroxyl ratio of about 1:1; that is, when one equivalent of isocyanate (—NCO) reacts with one equivalent of hydroxyl (—OH). Typically, however, a small excess of isocyanate, about 5-10%, is used to allow for the loss of isocyanate by the reaction with adventitious moisture from the atmosphere, solvents, and pigments. Other NCO:OH ratios can be used; for example, it may be desirable to vary the NCO to OH ratio to less than 1:1 to improve flexibility or greater than 1:1 to produce harder, more chemical resistant coatings.

For the present invention, the solvent borne thermosetting coating composition has an NCO:OH ratio of from about 0.9:1.0 to about 1.5:1.0. Examples of other NCO:OH ratios are about 0.95:1.0 to about 1.25:1.0 and about 0.95:1.0 to about 1.1:1.0.

The thermosetting coating composition also comprises about 30 to about 70 weight percent of at least one solvent, based on the total weight of the curable polyester, isocyanate, and the solvent. Examples of solvents include, but are not limited to, benzene, xylene, mineral spirits, naphtha, toluene, acetone, methyl ethyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate (available commercially from Eastman Chemical Co. under the trademark TEXANOL™), AROMATIC 100 (C9-10 dialkyl and trialkylbenzenes), AROMATIC 150 (C10 aromatics, >1% naphthalene) or AROMATIC 200 (C10-13 aromatics, >1% naphthalene) available commercially from Exxon Mobile Corporation or combinations thereof. Typically, the coating composition of this invention will comprise about 30 to about 90 weight percent solids (i.e., non-volatiles), based on the total weight of the coating composition. Some additional examples of weight percent solids for the coating composition of the invention are 50, 60, 65, 70, 75, 80, and 85 weight percent.

In another embodiment, the curable aromatic polyester can comprise hydroxyl-terminated end groups and the crosslinker can comprise at least one isocyanate and a crosslinking catalyst.

Examples of isocyanate crosslinking catalysts include FASCAT™ 4102 (monobutyltin tris (2-ethylhexanoate)), FASCAT™ 4100 (monobutyltin oxide) both available from PMC Organoletallix™, DABCO® T-12 (dibutyltin dilaurate) available from Air Products and K-KAT™ 348 (bismuth carboxylate catalyst), K-KAT™ 4205 (zirconium chelate complex), K-KAT™ 5218 (aluminum chelate complex), K-KAT™ XC-6212TH (zirconium chelate complex) non-tin catalysts available from King Industries and tertiary amines such as trialkylamines, for example triethylene amine, triethylene diamine and the like.

The term “residue”, as used herein in reference to the polymers of the invention, means any organic structure incorporated into a polymer through a polycondensation or ring opening reaction involving the corresponding monomer. It will also be understood by persons having ordinary skill in the art, that the residues associated within the various curable polyesters of the invention can be derived from the parent monomer compound itself or any derivative of the parent compound. For example, the dicarboxylic acid residues referred to in the polymers of the invention may be derived from a dicarboxylic acid monomer or its associated acid halides, esters, salts, anhydrides, or mixtures thereof. Thus, as used herein, the term “dicarboxylic acid” is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a curable, aliphatic polyester.

### EXAMPLES

We explored the possible utility of TMCD to provide polyesters with high glass transition temperatures and high sterilization resistance without high molecular weight and the associated low solids issue. Compositions were evaluated in a series of standard tests using a generic pigmented or clear coating formulation containing isophorone diisocyanate (IPDI) and catalyst cured at 200° C. for 12-minute thermal cycle.

### Polyester Polyol Synthesis

The polyols were produced using a resin kettle reactor setup controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point (Aromatic 100 or Aromatic 150) was used to both encourage egress of the water condensate out of the reaction mixture and to control viscosity using a paddle stirrer. Isophthalic acid (IPA), terephthalic acid (TPA), 1,4-cyclohexane dimethanol (CHDM), 2,2,4,4-tetramethylcyclobutanediol (TMCD), 1,6-hexanediol (HDO), and AROMATIC 150 were added to the reactor which was then completely assembled. Butyl tin trisethylhexanoate (FASCAT™ 4102 available commercially from PMC Organometallix, Inc.) was added via the sampling port after the reactor had been assembled and blanketed with nitrogen for the reaction. Additional SHELLSOLT™ A150 (a mixture of C 9-11 hydrocarbons with >99% aromatic content) and SHELLSOL™ A150 ND (C9-C10 aromatic hydrocarbon solvent with a naphthalene content below 1% m/m), available commercially from Shell Chemicals, was added to a Dean Stark trap to maintain an approximate 10 weight percent solvent level in the reaction kettle. The reaction mixture was heated without stirring from room temperature to 150° C. using a set output controlled through the automation system. Once the reaction mixture was fluid enough, stirring was started to encourage even heating of the mixture. At 150° C., the control of heating was switched to automated control and the temperature was ramped to 230° C. over the course of 4 hours. The reaction was held at 230° C. for 1 hour and then heated to 240° C. over the course of 1 hour. The reaction was then held at 240° C. and sampled every 0.5-1 hours upon clearing until the desired acid value was reached. The reaction mixture was then further diluted with SHELLSOL™ A100 (available commercially from Shell Chemicals) to target a weight percent solid of 60%. The solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the same molecular weight with simply different acid and hydroxyl end levels.

### Polyester Resin Molecular Properties Characterization

Absolute molecular weights were determined based on polyol end groups (acid and hydroxyl) using the formula: MW=56100/(total ends)×(functionality). The glass transition temperature (T_{g}) was determined using differential scanning calorimetry (DSC) at a 20° C./min ramp rate with a nitrogen sweep. The glass transition temperatures are based on second heat thermograms. The inherent viscosities were determined in a 60/40 weight ratio solvent blend of phenol/1,1,2,2-tetrachloroethane using an Ubbelohde viscometer. Acid numbers were determined using colorimetric titration in pyridine with phenolphthalein indicator and a 0.1 N KOH titrant administered with an auto-dispensing titrator. The hydroxyl numbers were determined using a specialized ³¹P NMR analysis. A “solvent solution” was first prepared by weighing 0.0060 g of the internal standard, cyclohexanol, into a vial and recording the mass. To this, 0.0008 g of the relaxation agent, chromium (III) acetylacetonate, was added. To the same vial were added 6.15 mL of pyridine and 3.85 mL of deuterated chloroform, to give a total of 10 mL of solvent solution. A PTFE-coated stirring bar was added. The vial was capped and the solvent solution was allowed to mix thoroughly. A batch of solvent solution may be used for additional samples for 7 days after preparation. Analyses with solvent solution older than this have not been carried out.

Sample preparation involved weighing 0.0300 g±0.005 g of sample into a septum vial and recording the mass. A stirring bar was added. Using a calibrated pipette, 1 mL of the solvent solution described above was added. Care must be taken to measure 1 mL accurately, as the solvent solution contains the internal standard. The sample was then placed on a stirring plate at room temperature to dissolve. Once dissolved, 35 μL of the phosphorylation agent, 2-chloro-4,4,5,5-tetramethyl-1,3,2-dioxaphospholane, was added via calibrated pipette, and the vial was capped with a screw cap that was fitted with a septum. This reaction mixture was allowed to stir for 30 minutes at room temperature before being transferred to a 5 mm NMR tube and subjected to ³¹P NMR analysis. The headspace of the 2-chloro-4,4,5,5-tetramethyl-1,3,2-dioxaphospholane container was flushed with nitrogen and the reagent was stored in a desiccator when not in use.

The hydroxyl numbers and acid number in units of mg KOH per g of polymer are calculated using the following equation:

$$Hydroxyl or acid number = \frac{Area of sample}{Area of cyclohexanol} \times \frac{Mass cyclohexanol ( g )}{100.158 ( \frac{g}{mol} )} \times \frac{1}{Sample mass ( g )} \times 56111$$

NMR spectra were acquired using a 600 MHz Agilent spectrometer with the following parameters:
Pulse program: s2pul
Number of points: 20361
Number of transients: 64
Relaxation delay: 10 s
Pulse angle: 45 degrees
1H decoupling: decoupled —NOE
Temperature: 26.0° C.
Spectrum width: 128.1 to 178.1

### Integration

The spectra needed to be phased and baseline corrected, with care taken around the cyclohexanol peak. Spectra were then referenced to the large water/2-chloro-4,4,5,5-tetramethyl-1,3,2-dixaphospholane at 132.2 ppm. Proper integration ranges are shown below.

| | |
|---|---|
| Carboxylic acids | 135.00 . . . 135.45 ppm |
| Cyclohexanol (area is set to 1) | 145.00 . . . 145.35 ppm |
| Secondary hydroxyls | 146.00 . . . 146.80 ppm |
| Primary hydroxyls | 146.80 . . . 148.00 ppm |

Calculations were performed using the equation above and the appropriate integration regions to determine the primary hydroxyl number, secondary hydroxyl number, and acid number.

### Metal/Coil Coating Formulations

The polyol examples produced via the above procedure are shown in Table 1 and were incorporated into formulations as described in Table 2 for the testing. The polyester was first diluted in AROMATIC100 to 55% weight solids. The titanium dioxide pigment was then added to the polyester solution and sheared for 5 minutes at 3000 rpm with a Cowles blade on a DISPERMAT™ high speed disperser. The remaining ingredients were weighed out into a glass jar and rolled overnight with slight agitation at ambient conditions. A food grade approved isocyanate, DESMODUR®VP LS 2078 available commercially from Covestro AG was chosen as the crosslinker.

The amount of crosslinker in the clear formulations is defined by the information in Table 2a and the amount of crosslinker in the pigmented formulations is defined by the information in Table 2b, except for Samples 23 which is defined in Table 2c and Sample 24 which is defined by the information in Table 2d.

TABLE 1
Compositional Changes
Compositional Series

| | Sample | Sample | Sample | Sample | Sample | Sample | Sample | Sample |
|---|---|---|---|---|---|---|---|---|
| Monomer | 1 | 2 | 3 | 4 | 5 | 6 | 7 | 8 |

Compostion (mol %)

| | | | | | | | | |
|---|---|---|---|---|---|---|---|---|
| terephthalic acid | 30 | 30 | 30 | 40 | 30 | 30 | 30 | 40 |
| isophthalic acid | 70 | 20 | 70 | 20 | 70 | 20 | 70 | 20 |
| 1,4-cyclohexane | 0 | 50 | 0 | 40 | 0 | 50 | 0 | 40 |
| dicarboxylic acid | | | | | | | | |
| 2,2,4,4- | | | | | | | | |
| tetramethyl | 40 | 60 | 60 | 60 | 40 | 60 | 60 | 60 |
| cyclobutanediol | | | | | | | | |
| 1,4-cyclohexane | 40 | 20 | 40 | 40 | 40 | 20 | 40 | 40 |
| dimethanol | | | | | | | | |
| 1,6-hexanediol | 20 | 20 | 0 | 0 | 20 | 20 | 0 | 0 |

Properties

| | | | | | | | | |
|---|---|---|---|---|---|---|---|---|
| IhV (dl/g) | 0.297 | 0.271 | 0.248 | 0.279 | 0.297 | 0.271 | 0.21 | 0.279 |
| Acid Value | 3 | 3 | 3 | 3 | 3 | 3 | 3 | 3 |
| (mg KOH/g) | | | | | | | | |
| Resin T_{g} (° C.) | 80 | 80 | 110 | 100 | 80 | 80 | 100 | 100 |
| coating T_{g} (° C.) | 100 | 99 | 133 | 121 | 95 | 101 | 133 | 133 |
| Formulations | 31% | 31% | 31% | 31% | clear | clear | clear | clear |
| | TiO2 | TiO2 | TiO2 | TiO2 | | | | |
| Wedge Blend | 62 | 35 | 33 | 43 | 3 | 4 | 27 | 9 |
| (% fail) | | | | | | | | |
| Acetone DR's | 70 | 70 | 70 | 70 | 70 | 70 | 60 | 70 |
| LAS retort | 6.4 | −19.5 | 0.3 | −2.4 | −58 | −76 | −29 | −33 |
| (Δ 20° gloss) | | | | | | | | |

TABLE 2
Polyester metal/coil coating formulations.

| | |
|---|---|
| Component/Description | grams |

(a) Clear formulation

| | |
|---|---|
| Polyester polyol (55% NV in A150/A100) | 36 |
| Fascat 9102 catalyst | 0.135 |
| Desmodur VP LS 2078 (60% in A100) | 7.7 |
| A100 reducing solvent | 15.0 |
| Total | 58.84 |

(b) Pigmented formulation

| | |
|---|---|
| Polyester polyol (55% NV in A150/A100) | 80 |
| TiO2 pigment | 60 |
| Fascat 9102 catalyst | 0.3 |
| Desmodur VP LS 2078 (60% in A100) | 17.2 |
| A100 reducing solvent | 33.3 |
| Total | 190.8 |

(c) Sample 23 Coating Formulation

| | |
|---|---|
| Polyester polyol (55% in A-100) | 20.3 |
| M-cresol phenol | 8.0 |
| Desmodur VP LS 2078 (60% in A100) | 0 |
| H₃PO₄ catalyst | 0.38 |
| Fascat 9102 catalyst | 0 |
| A100 reducing solvent | 11.3 |
| Total | 40 |

(d) Sample 24 Coating Formulation

| | |
|---|---|
| Polyester polyol (55% in A-100) | 23.2 |
| m-cresol phenol | 2.9 |
| Desmodur VP LS 2078 (60% in A100) | 2.9 |
| H₃PO₄ catalyst | 0 |
| Fascat 9102 catalyst | 0.1 |
| A100 reducing solvent | 11.5 |
| Total | 40.6 |

### Substrate, Coated Test Panel Preparation, Film Thickness

Electro tin plate (ETP) substrate panels were described by the vendor, Lakeside Metals Inc. as 0.25 # Bright T-1 0.009-0.010×4″×12″. The substrate was coated with the formulations described above by casting wet films with wire wound rods, RDS 28 for pigmented and RDS 22 for clear (RDS 28 and RDS 22 available from R.D. Specialties, Inc.). This yielded a final dry film thickness (DFT) of ˜0.6 and 0.4 mils for pigmented and clear coatings, respectively. The coated panels were allowed to flash for 15 minutes at constant temperature and humidity conditions (73° F.±2/50% RH±5). The cast panels were placed in a rack to hold them vertically in an oven for cure. A Despatch forced air oven was preset to a temperature of 200° C. The temperature dropped 5 to 6 degrees due to the opening of oven door. The oven was allowed to recover to 200° C. (typically taking about 1 minute) before starting bake cycle time of 12 minutes. At the conclusion of baking cycle, the panel rack was removed from oven and allowed to cool back to ambient conditions. A Fischer scope Dualscope model FMP40 handheld thickness gauge was used to confirm the dry film thickness of the applied coatings.

### Wedge Bend

A coupon measuring 1.5″ wide×4″ long was cut from the coated panel. This coupon was tested by a Gardco coverall bend and impact tester following ASTM method D 3281. Once the coupon was bent into a wedge shape it was soaked in a copper sulfate solution for 5 minutes to make any coating cracking visible. Excess copper sulfate solution was removed by blotting with a dry towel. The failure of the coating was measured by using a ruler and a lighted magnifying glass. Failure was reported as percent failure.

### Acetone Double Rubs

The resistance to the solvent acetone was measured using a double rub test method. This test was carried out similar to ASTM D 5402 with the following exceptions incorporated. A cotton ball was soaked in acetone and placed into locking forceps. The soaked cotton ball was rubbed in a back and forth motion until a failure to substrate occurred. Acetone solvent resistance was reported as the number of double rubs. For example, one back-and-forth motion constitutes one double rub. A maximum of 70 double rubs was set as the upper limit for each evaluation.

### Sterilization Resistance Testing

A coupon measuring 2.5″ wide×4″ long was cut from the coated panel. The coupons were then placed in 250 mL glass beakers half filled with the food simulant where half the coupon is out the water and the other half submerged in water. Three different food simulants were evaluated:
Lactic acid, acetic acid & salt (LAS): 1% lactic acid, 1% acetic acid, 1% NaCl, 97% DI water
Citric acid & salt: 1% citric acid, 3% NaCl, 96% DI water
Acetic Acid: 3% acetic acid, 97% dionized water.

The beakers were placed in an autoclave for one hour. LAS samples were tested at 121° C. and the other two food simulants were tested at 131° C. After 60 minutes of operation, the autoclave was allowed to depressurize to ambient conditions. The beakers containing the test coupons were then removed from the autoclave and the coupons blotted dry with dry paper towels. Typically, the retort performance is ranked using a visual observation of blush and measured on a scale of 1 to 5 or 1 to 10. To better quantify the retort performance, gloss measurements were used to evaluate performance after LAS retort on flat panels in this study. Prior to and after LAS retort testing, a BYK Gardner micro-TRI-gloss μ Gloss and Film thickness instrument was used to collect gloss readings on the test coupons. The ‘before retort’ gloss reading was not necessarily taken on the exact same area that was affected by the retort testing. Gloss readings were collected at 20°. A three reading average was reported. The ‘after retort’ gloss reading was taken on the bottom half of the panel that was submerged in water during the retort test. The delta gloss was calculated by subtracting the initial gloss reading from the post retort gloss reading.

### Beading

Some samples were beaded after casting and curing the coating on the substrate to mimic stresses imparted during can manufacturing. The “beader” was fabricated in the machine shop. A coupon measuring 2.5″ wide×4″ long was cut from the coated panel and the coupon was placed between the two plates of the beader. A hydraulic press was used to apply force between the bottom and top plates to bead the samples. The dimensions of the beads formed are similar to those measured in a deconstructed generic commercial food can. Standard clear package tape was applied to the beaded panels to measure adhesion of the coating.

### Differential Scanning Calorimetry (DSC)

For DSC measurements, the coatings were cast at a wet DFT of 10 mils on a glass substrate and cured at the standard cure condition. The sample was removed from the glass with a razor blade and submitted to analytical for testing with first and second heat. The sample was heated from −50 to 250° C. at 20° C./min.

Over the course of the investigation to explore these compositions, several compositional characteristics were evaluated to determine their practical effect on basic coating properties including sterilization resistance. The molecular weight (Table 3) and architecture (Table 4) (branching within limited range) appeared to show little influence on the performance properties of wedge bend, acetone double rubs, and simulant sterilization resistance. On the other hand, residual acid functionality, glass transition temperature, and compositional aromaticity showed some level of influence over the performance of polyols in the coating formulations.

TABLE 3
Molecular Weight (MW)
MW Series (all samples)

| | Sample | Sample | Sample | Sample | Sample |
|---|---|---|---|---|---|
| Monomer | 9 | 10 | 11 | 12 | 13 |

Composition (mol %)

| | | | | | |
|---|---|---|---|---|---|
| dimethyl terephthalate | 30 | 30 | 30 | 30 | 30 |
| dimethyl isophthalate | 70 | 70 | 70 | 70 | 70 |
| 2,2,4,4-tetramethyl | 60 | 60 | 60 | 60 | 60 |
| cyclobutanediol | | | | | |
| 1,4-cyclohexane | 40 | 40 | 40 | 40 | 40 |
| dimethanol | | | | | |

Properties

| | | | | | |
|---|---|---|---|---|---|
| IhV (dL/g) | 0.186 | 0.193 | 0.244 | 0.261 | 0.27 |
| Acid Value | <0.5 | <0.5 | <0.5 | <0.5 | <0.5 |
| (mg KOH/g) | | | | | |
| Resin T_{g} (° C.) | 98 | 99 | 105 | 108 | 110 |
| coating Tg (° C.) | 132 | 128 | 122 | 125 | 128 |
| Formulation | clear | clear | clear | clear | clear |
| Wedge Bend | 0 | 0 | 1 | 1 | 0 |
| (% fail) | | | | | |
| Acetone DR's | 13 | 15 | 14 | 8 | 8 |
| LAS retort | −9 | −15 | −19 | −16 | −13 |
| (Δ 20° gloss) | | | | | |

TABLE 4
Branching Effects
Branching Effects

| | Sample | Sample | Sample | Sample | Sample | Sample | Sample | Sample | Sample | Sample | Sample |
|---|---|---|---|---|---|---|---|---|---|---|---|
| Monomer | 14 | 15 | 16 | 17 | 18 | 19 | 20 | 21 | 22 | 23 | 24 |

Composition (mol %)

| | | | | | | | | | | | |
|---|---|---|---|---|---|---|---|---|---|---|---|
| terephthalic acid | 30 | 30 | 30 | 30 | 35 | 30 | 30 | 35 | 35 | 30 | 30 |
| isophthalic acid | 70 | 70 | 70 | 70 | 65 | 70 | 70 | 65 | 65 | 70 | 70 |
| 2,2,4,4-tetramethyl | 60 | 60 | 60 | 60 | 50 | 40 | 40 | 40 | 40 | 60 | 60 |
| cyclobutanediol | | | | | | | | | | | |
| 1,4-cyclohexane | 40 | 39 | 38 | 36 | 36 | 40 | 36 | 20 | 16 | 36 | 36 |
| dimethanol | | | | | | | | | | | |
| 1,6-hexanediol | 0 | 0 | 0 | 0 | 10 | 20 | 20 | 40 | 40 | 0 | 0 |
| trimethylol propane | 0 | 1 | 2 | 4 | 4 | 0 | 4 | 0 | 4 | 4 | 4 |

Properties

| | | | | | | | | | | | |
|---|---|---|---|---|---|---|---|---|---|---|---|
| IhV (dL/g) | 0.248 | 0.233 | 0.254 | 0.297 | 0.254 | 0.297 | 0.286 | 0.296 | 0.298 | 0.297 | 0.254 |
| Acid Value | 3 | 3 | 3 | 2 | 3 | 3 | 3 | 4 | 4 | 2 | 3 |
| (mg KOH/g) | | | | | | | | | | | |
| Resin T_{g} (° C.) | 110 | 109 | 108 | 105 | 95 | 80 | 80 | 60 | 60 | 107 | 95 |
| coating Tg (° C.) | 133 | 130 | 130 | 133 | 118 | 100 | 99 | 79 | 87 | 118 | 101 |
| Formulation | 31% | 31% | 31% | 31% | 31% | 31% | 31% | 31% | 31% | clear | clear |
| | TiO2 | TiO2 | TiO2 | TiO2 | TiO2 | TiO2 | TiO2 | TiO2 | TiO2 | | |
| Wedge Bend | 33 | 46 | 50 | 80 | 67 | 62 | 50 | 20 | 48 | 17 | 100 |
| (% fail) | | | | | | | | | | | |
| Acetone DR's | 70 | 70 | 70 | 70 | 70 | 70 | 70 | 70 | 70 | 50+ | 50+ |
| LAS retort | 0.3 | −0.7 | −1 | 0 | 1.3 | 6.4 | −31.4 | −43.8 | −10.6 | 0 | −36 |
| (Δ 20° gloss) | | | | | | | | | | | |

Initial compositional design efforts focused on modification of low glass transition temperature, medium molecular weight materials with TMCD in an effort to potentially modify the coating properties. It was found that the level of TMCD corresponded directly with the resulting glass transition temperature of the polyester polyol. Further it was found that in an isocyanate system, the polyester polyol glass transition temperature correlated strongly with sterilization resistance performance. A series of TMCD based polyester polyols was produced with glass transition temperatures targeted at 40, 60, 80, and 110° C. These materials were produced and the compositional information can be found in Table 5.

TABLE 5
T_{g}
T_{g} Series

| | | | | |
|---|---|---|---|---|
| Monomer | Sample 25 | Sample 26 | Sample 27 | Sample 28 |

Composition (mol %)

| | | | | |
|---|---|---|---|---|
| terephthalic acid | 35 | 35 | 30 | 30 |
| isophthalic acid | 65 | 65 | 70 | 70 |
| 2,2,4,4-tetramethyl | 15 | 40 | 40 | 60 |
| cyclobutanediol | | | | |
| 1,4-cyclohexane | 0 | 20 | 40 | 40 |
| dimethanol | | | | |
| 1,6-hexanediol | 50 | 40 | 20 | 0 |
| neopentyl glycol | 35 | 0 | 0 | 0 |

Properties

| | | | | |
|---|---|---|---|---|
| IhV (dL/g) | 0.258 | 0.296 | 0.297 | 0.248 |
| Acid Value | 3 | 4 | 3 | 3 |
| (mg KOH/g) | | | | |
| Resin T_{g} (° C.) | 40 | 60 | 80 | 110 |
| coating Tg (° C.) | 53 | 79 | 100 | 133 |
| Formulation | 31% TiO2 | 31% TiO2 | 31% TiO2 | 31% TiO2 |
| Wedge Bend | 0 | 20 | 62 | 33 |
| (% fail) | | | | |
| Acetone DR's | 70 | 70 | 70 | 70 |
| LAS retort | −40.2 | −43.8 | 6.4 | 0.3 |
| (Δ 20° gloss) | | | | |

The various polyesters across the glass transition temperature design range were formulated into an isocyanate based coating. For a pigmented coating, the polyols with glass transition temperatures of approximately 80° C. showed performance expected to pass customer requirements for sterilization performance. For clear, unpigmented formulations, a coating having a glass transition temperature of about 100° C. appeared necessary to achieve the desired performance in sterilization resistance. Table 6 also details the performance of the polyols from the glass transition temperature series in the coatings performance tests.

Subsequent to establishing the strong effect of glass transition temperature on the sterilization difference, the polyol synthesis was used to create an acid series which would help to elucidate any effects of residual acid ends on the various application areas including but not limited to reactivity. A series was hypothesized and generated manipulating the acid value for a constant polyester composition (Table 6) from 0 to 6 mg KOH/g. Table 6 below details the resulting polyols and their properties. Samples 29 and 33 dimethyl terephthalate was used in place of terephthalic acid and dimethyl isophthalate was used in place of isophthalic acid.

TABLE 6
Acid Value
Acid Value Series

| | Sample 29 | Sample | Sample | Sample | Sample 33 | Sample | Sample | Sample | Sample |
|---|---|---|---|---|---|---|---|---|---|
| Monomer | (DMT/DMI) | 30 | 31 | 32 | (DMT/DMI) | 34 | 35 | 36 | 37 |

Composition (mol %)

| | | | | | | | | | |
|---|---|---|---|---|---|---|---|---|---|
| terephthalic acid | 30 | 30 | 30 | 30 | 30 | 30 | 30 | 30 | 30 |
| isophthalic acid | 70 | 70 | 70 | 70 | 70 | 70 | 70 | 70 | 70 |
| 2,2,4,4-tetramethyl | 40 | 40 | 40 | 40 | 60 | 60 | 60 | 60 | 45 |
| cyclobutanediol | | | | | | | | | |
| 1,4-cyclohexane | 40 | 40 | 40 | 40 | 40 | 40 | 40 | 40 | 45 |
| dimethanol | | | | | | | | | |
| 1,6-hexanediol | 20 | 20 | 20 | 20 | 0 | 0 | 0 | 0 | 10 |
| trimethylol propane | 0 | 0 | 0 | 0 | 0 | 0 | 0 | 0 | 0 |

Properties

| | | | | | | | | | |
|---|---|---|---|---|---|---|---|---|---|
| IhV (dL/g) | 0.261 | 0.295 | 0.297 | 0.286 | 0.264 | 0.248 | 0.246 | 0.245 | 0.457 |
| Acid Value | 0 | 0.5 | 3 | 6 | 0 | 3 | 5 | 8 | 3 |
| (mg KOH/g) | | | | | | | | | |
| Resin T_{g} (° C.) | 80 | 80 | 80 | 80 | 110 | 110 | 110 | 110 | 100 |
| coating Tg (° C.) | 97 | 94 | 100 | 93 | 119 | 132 | 131 | 133 | 108 |
| Formulation | 31% | 31% | 31% | 31% | 31% | 31% | 31% | 31% | 31% |
| | TiO2 | TiO2 | TiO2 | TiO2 | TiO2 | TiO2 | TiO2 | TiO2 | TiO2 |
| Wedge Bend | 92 | 85 | 62 | 73 | 100 | 65 | 75 | 79 | 41 |
| (% fail) | | | | | | | | | |
| Acetone DR's | 32 | 55 | 70 | 70+ | 5 | 70 | 70 | 70 | 70 |
| LAS retort | 6.3 | 5.4 | 6.4 | 10.7 | 1.15 | −0.7 | −0.5 | −3.9 | −1 |
| (Δ 20° gloss) | | | | | | | | | |

It should be noted that the polyols in Samples 29 and 33 with 0 mg KOH/g acid value are produced using dimethyl terephthalate and dimethyl isophthalate to ensure minimal acid residues. The molecular weights as reflected in the inherent viscosity (IhV) for all the samples were similar and further the end group analysis showed primarily similar total ends confirming the similar nature of the polyol molecular weights (samples 29-36). Sample 37 was included to demonstrate the resulting performance at a higher molecular weight. These polyols were formulated into a coating, applied to the substrate and cured. Analysis of the acetone double initially showed increasing double rub resistance as the residual acid value moved from about 0 mg KOH/g to about 6 mg KOH/g. The wedge bend showed similar performance improvement with increasing acid value. The LAS gloss loss values demonstrated a slightly different trend only showing slightly poorer performance when the acid value reached about 6 mg KOH/g. Further sterilization testing with the other simulants (3% acetic acid and citric acid/salt) on scribed, beaded panels showed optimum performance at 3 mg KOH/g acid. Based on the cumulative evaluation of all these test results, an optimum acid value for peak polyol coating performance was 3 mg KOH/g with a range of 1-6 mg KOH/g being acceptable.

A specific combination of polyol end groups including an acid value between 1 mg KOH/g and 6 mg KOH/g with an all aromatic acid composition leading to a polyol with a glass transition temperature greater than 75° C. demonstrated unique performance properties in a pigmented isocyanate coating formulation. The acid end groups enabled the desired curing performance when measured using acetone double rubs. The presence of TMCD enabled the desired glass transition temperature greater than 75° C. at the desired absolute molecular weights of 4000 g/mol to 18000 g/mol. An all aromatic acid composition combined with the specified resin glass transition temperature yielded a composition that provides the desired sterilization performance. The specific combination of composition and end groups provides a material with a unique combination of properties related to metal packaging coatings.

Although the polyesters disclosed herein are particularly useful for coating metal can ends, the polyesters may also be useful for coating other metal surfaces in food contact and non-food applications such as metal packaging, coil, caps and closures, foils, tubes, and aerosol cans.

TMCD polyester polyols have molecular weight and compositional ranges that enable the development of polyols with glass transition temperatures of from below room temperature to greater than 100° C. However, it is unique that TMCD allows the generation of high glass transition temperatures (>75° C.) polyols at lower molecular weights. In essence, it allows simultaneous high glass transition temperatures and high solids leading to improved sterilization resistance without the use of multiple coating applications to achieve a desired dry film thickness (DFT) on metal surfaces.

The invention has been described in detail with particular reference to preferred embodiments thereof, but it will be understood that variations and modifications can be effected within the spirit and scope of the invention.

We claim:

1. A polyester for use in metal food packaging applications consisting of residues of:
(a) at least one aromatic acid;
(b) 2,2,4,4-tetramethyl-1,3-cyclobutanediol; and
(c) at least one polyol different than 2,2,4,4-tetramethyl-1,3-cyclobutanediol;
wherein the polyester has a glass transition temperature of greater than 75° C., an acid value of 1 KOH/g to 6 KOH/g, and a number average absolute molecular weight of 4000 g/mol to 18000 g/mol.

2. The polyester of claim 1 wherein said aromatic acid is isophthalic acid, or terephthalic acid or a combination thereof.

3. The polyester of claim 1 wherein said polyol I is 1,4-cyclohexane dimethanol, 1,3-cyclohexane dimethanol, neopentyl glycol, ethylene glycol, 2-methyl 1,3-propane diol, 1,6-hexanediol, trimethylol propane, or a combination thereof.

4. A polyester for use in metal food packaging applications comprising residues of:
(a) isophthalic acid, or terephthalic acid or a combination thereof;
(b) 2,2,4,4-tetramethyl-1,3-cyclobutanediol; and
(c) 1,4-cyclohexane dimethanol, 1,3-cyclohexane dimethanol, neopentyl glycol, ethylene glycol, 2-methyl 1,3-propane diol, 1,6-hexanediol, trimethylol propane, or a combination thereof;
wherein the polyester has a glass transition temperature greater than 75° C., an acid value of 1 KOH/g to 6 KOH/g, and a number average absolute molecular weight of 4000 g/mol to 18000 g/mol.

5. A metal food packaging coating composition comprising:
A. A polyester consisting of residues of:
(a) at least one aromatic acid;
(b) 2,2,4,4-tetramethyl-1,3-cyclobutanediol; and
(c) at least one polyol different than 2,2,4,4-tetramethyl-1,3-cyclobutanediol;
wherein the polyester has a glass transition temperature greater than 75° C., an acid value of 1 KOH/g to 6 KOH/g, and a number average absolute molecular weight of 4000 g/mol to 18000 g/mol; and
B. a crosslinking composition.

6. The metal food packaging coating composition of claim 5 wherein said crosslinking composition is an isocyanate composition, a phenolic composition, an amino composition or a mixture thereof.

7. The metal food packaging coating composition of claim 6 wherein said isocyanate composition is isophorone diisocyanate.

8. The metal food packaging coating composition of claim 6 wherein said phenolic compositions is cresol or a phenolic resin.

9. The metal food packaging coating composition of claim 6 wherein said amino composition is melamine or benzoguamine.

10. A metal food packaging coating composition comprising:
A. A polyester comprising residues of:
(a) Isophthalic acid, or terephtalic acid or a combination thereof;
(b) 2,2,4,4-tetramethyl-1,3-cyclobutanediol; and
(c) 1,4-cyclohexane dimethanol, 1,3-cyclohexane dimethanol, neopentyl glycol, ethylene glycol, 2-methyl 1,3-propane diol, 1,6-hexanediol, trimethylol propane; or combinations thereof;
wherein the polyester has a glass transition temperature greater than 75° C. and an acid value of 1 mg KOH/g to 6 mg KOH/g; and a number average absolute molecular weight of 4000 g/mol to 18000 g/mol
B. a crosslinking composition consisting of an isocyanate composition, a phenolic composition or an amino composition or a mixture thereof.

11. The metal food packaging coating composition of claim 10 wherein said isocyanate composition is isophorone diisocyanate.

12. The metal food packaging coating composition of claim 10 wherein said phenolic compositions is cresol or a phenolic resin.

13. The metal food packaging coating composition of claim 10 wherein said amino composition is melamine or benzoguamine.

14. A metal coating composition, comprising:
(A). about 3 weight percent to about 40 weight percent, based on the total weight of (A), (B), and (C) of an aromatic polyester, consisting of
i. residues of at least one aromatic diacid;
ii. 2,2,4,4-tetramethyl-1,3-cyclobutanediol residues; and
iii. 1,4-cyclohexane dimethanol, 1,3-cyclohexane dimethanol, neopentyl glycol, ethylene glycol, 2-methyl 1,3-propane diol, 1,6-hexanediol, trimethylol propane or combinations thereof residues
wherein said curable, aromatic polyester has a number average absolute molecular weight of from about 4000 g/mol to about 18000 g/mol, a glass transition temperature of greater than 75° C. and an acid number of 1 mg KOH/g to about 6 mg KOH/g of polyester;
(B). about 5 weight percent to about 20 weight percent, based on the total weight of (A), (B), and (C), of at least one crosslinker; and
(C). about 30 weight percent to about 70 weight percent, based on the total weight of (A), (B), and (C), of at least one solvent; wherein the total weight percent of (A), (B), and (C) equals 100 weight percent.

15. The composition of claim 14 further comprising (D) about 10 weight percent to about 40 weight percent, based on the total weight of (A), (B), (C) and (D) of at least one pigment compound and wherein the total weight percent of (A), (B), (C) and (D) equals 100 weight percent.

16. The composition of claim 15 wherein said at least one pigment compound is a titanium dioxide compound.

17. The metal food packaging coating composition of claim 14 wherein said isocyanate composition is isophorone diisocyanate.

18. The metal food packaging coating composition of claim 14 wherein said phenolic compositions is cresol or other functional phenol based phenolic resins.

19. The metal food packaging coating composition of claim 14 wherein said amino composition is melamine or benzoguamine.

20. A metal coating composition, comprising:
(A). about 3 weight percent to about 40 weight percent, based on the total weight of (A), (B), and (C) of an aromatic polyester, consisting of
(i) residues of at least one aromatic diacid;
(ii) 30 mole percent to 90 mole percent 2,2,4,4-tetramethyl-1,3-cyclobutanediol residues, based on the total moles of (ii) and (iii); and
(iii) 10 mole percent to 70 mole percent 1,4-cyclohexane dimethanol, 1,3-cyclohexane dimethanol, neopentyl glycol, ethylene glycol, 2-methyl 1,3-propane diol, 1,6-hexanediol, trimethylol propane or a combination thereof residues based on the total moles of (ii) and (iii),
wherein said curable, aromatic polyester has a number average absolute molecular weight of from about 4000 g/mol to about 18000 g/mol, a glass transition temperature of greater than 75° C., and an acid number of 1 mg KOH/g to about 6 mg KOH/g of polyester;
(B). about 5 weight percent to about 20 weight percent, based on the total weight of (A), (B), and (C), of at least one crosslinker; and
(C). about 30 weight percent to about 70 weight percent, based on the total weight of (A), (B), and (C), of at least one solvent; wherein the total weight percent of (A), (B), and (C) equals 100 weight percent.

21. The composition of claim 20 further comprising (D) about 10 weight percent to about 40 weight percent, based on the total weight of (A), (B), (C) and (D) of at least one pigment compound and wherein the total weight percent of (A), (B), (C) and (D) equals 100 weight percent.
